(19) United States
(12) Patent Application Publication
(10) Pub. No.: US 2003/0040397 A1
(43) Pub. Date: Feb. 27, 2003

(54) Bicycle front gearshift device

(76) Inventor: Chin-Fu Wu, Taipei City (TW)

Correspondence Address: WU, Chin-Fu, PO Box 82-144, TAIPEI, TW

(21) Appl. No.: 09/935,817

(22) Filed: Aug. 24, 2001

(51) Int. Cl. F16H 3/44

(52) U.S. Cl. 475/269

(57) ABSTRACT

The improved structure of bicycle front gearshift module is disclosed. The present bicycle front gearshift module requires no triggering thread device to change gearshift in motionless condition. The present invention has a crank pedestal mounted with a position collar and the inside of the position collar is coupled with a gear axle sleeve, which can move forward and backward. The gear axle sleeve is separately mounted with external gear of different diameter and in conjunction with the crank relative to a planetary gear module, which is mounted with the internal gear of the housing. The external side of the housing is mounted with a gear disc so that a user can directly control the slip motion of the gear axle sleeve in order to change the engagement of the internal and external gear sleeve and the planetary gear module.

### BACKGROUND OF THE INVENTION

(a) Field of the Invention

The present invention relates generally to bicycle front gearshift modular improvement, and in particular, a gearshift device having a primary and a secondary external gear sleeve of different diameters in conjunction with the crank mounted over a planetary gear modular special designed. The bicycle front gearshift device can directly change the gear disc rotation and also in a motionless condition as to achieve the purpose of the simplicity of structure.

(b) Description of the Prior Art

A conventional bicycle gearshift device (as shown in FIG. 6) comprises a front and a rear gearshift module. The front gearshift module 10 in conjunction with a five through-tube of the crank axle is mounted with lap over gear discs size; and a frame tube 15 having a securing seat 16, and a pivot having a front triggering thread module 10. This module 10 is connected to the gearshift thread with a triggering block 11 and is provided with a torsion spring 14 for the revert function of the triggering block 11. One pivot end of the triggering block 11 is mounted with a triggering chain 17 of the chain housing 12. Besides a push arm 13 has driven the chain housing 12 and a pivot connected to the triggering block 11. The pivot is also mounted at the securing seat 16 at the same time. When an user controls the gearshift thread to pull the triggering block 11, the push arm 13 drives the chain housing 12, so that the chain housing 12 will trigger a chain 17 corresponding to the gear disc (as shown in FIGS. 7A and 7B) in order to achieve the gearshift purpose. When the user releases the gearshift thread, the triggering block 11 will be reverted to normal with the function of the torsion spring 14. Meanwhile, the chain housing 12 will revert the chain 17 back to the original gear disc, forming the front gearshift module structure.

The rear gearshift module comprises a rear triggering thread module 20 and a tension adjustment module 25, wherein the module 20 having a connection plate 21 on both ends of chain wheel 22 & 23, and pivotally mounted with a tension adjustment module 25. The module 25 is in conjunction with the front part lever 26 having an internal reversion spring 261 and pivotally mounted at the connection plate 21. The front part lever 26 uses the gearshift thread to control the link 28 and is pivotally mounted with a latter part lever 27. The latter part 27 and the link 28 are secured with an extension spring 29 and pivotally mounted on the frame. The rear frame is in conjunction with a multistage of gear disc size (as shown in FIGS. 8A and 8B). When the user pulls the gearshift thread, the latter part lever 27 pivotally mounted with the link 28 can pass through the front part lever 26 to drive the connection plate 21 and will let the chain 17 to trigger it over to another stage of gear disc; also in conjunction with the function of the extension spring 29, when the gearshift thread is released, the connection plate 21 will be reverted. Meanwhile, the internal reversion spring 261 of the front part lever 26 relative to the chain 17 can overcome the tension of difference stages of the gear disc in order to avoid the chain 17 drops. So, in conjunction with the front and rear gearshift modules, these components can form into a multistage gearshift. However, the above mentioned front gearshift module is mounted at the five through-tube surrounding, and because of the crank for the bicycle pedals is mounted over there, in order to avoid the interference of the crank in rotation movement, the front gearshift modular design has restriction. The triggering thread module 10 requires a securing housing mounted on the frame, it also impacts on the frame design spring further. Moreover, it will be able to change the gearshift with at least half of the chain 17 corresponding to the gear disc, when it is in motion. Thus, the gearshift velocity slow and it only can be changed when the bicycle is in motion. Furthermore, there is no definitive design for the whole gearshift module, therefore, the front gearshift module is not easy to adjust with the change of gearshift, and this will also affect the convenient application.

### SUMMARY OF THE INVENTION

Accordingly, it is an object of the present invention to provide the following technical means to achieve the above-mentioned purpose and efficiency. In accordance with the present invention, the front gearshift module comprises a triggering module, an external gear module, a planetary gear module and an internal gear module; wherein;

(a) the triggering module: the triggering module has one edge of the crank pedestal engaged with a position collar, and the position collar circumference forms a sectional recess, inside the position collar, a securing thread plate of the triggering ring is provided, and the securing thread plate can pass through the sectional recess of the position collar, a triggering ring is different from the edge of the crank pedestal has two outward extending protrusion edge plates, inside the protrusion edge plate, a corresponding protrusion point is formed, and the position collar is also engaged with a press sleeve that can press down the triggering ring;

(b) the external gear module: the external gear module is provided with a gear axle sleeve that can pass through the press sleeve and the triggering ring, and a triggering axle sleeve is engaged with the press sleeve, and can only move in a horizontal movement without rotation, the external edge of the gear axle sleeve relative to the triggering ring of protrusion point is separately formed of a multistage of gearshift propel bending recess, and the external edge of the gear axle sleeve forms a set of teeth, one side of the gear axle sleeve pivotally mounted with a wheel seat having the same diameter with the teeth, and the wheel seat is engaged with a difference diameter of primary and secondary external gear sleeves, and these gear sleeves can couple with the teeth;

(c) the planetary gear module: the planetary gear module has the crank side face which is fastened with a number of axle levers, over the axle lever pivot is a big and small wheel of gears are mounted and these gears can engage with the primary and the secondary gear sleeves;

(d) the internal gear module: the internal gear module has a housing and the housing is coupled with an internal gear sleeve engaged with the gear big wheel of the planetary gear module, the external side of the housing is fastened with a gear disc.

These and other advantages of the present invention will become clear to those skilled in the art upon a study of the detailed description of the invention and of the several figures of the drawings

### BRIEF DESCRIPTION OF THE DRAWINGS

FIG. 1 is a perspective exploded view of the present invention illustrating the gearshift device of its assembly and related relation of the present invention.

FIG. 2 is a plan sectional view of the primary stage gearshift according to the present of invention.

FIG. 3 is a plan sectional view of the secondary stage gearshift according to the present of invention.

FIG. 4 is a plan sectional view of the third stage gearshift according to the present of invention.

FIG. 5 is an external schematic view of the present invention.

FIG. 6 is a perspective view of the conventional bicycle gearshift device.

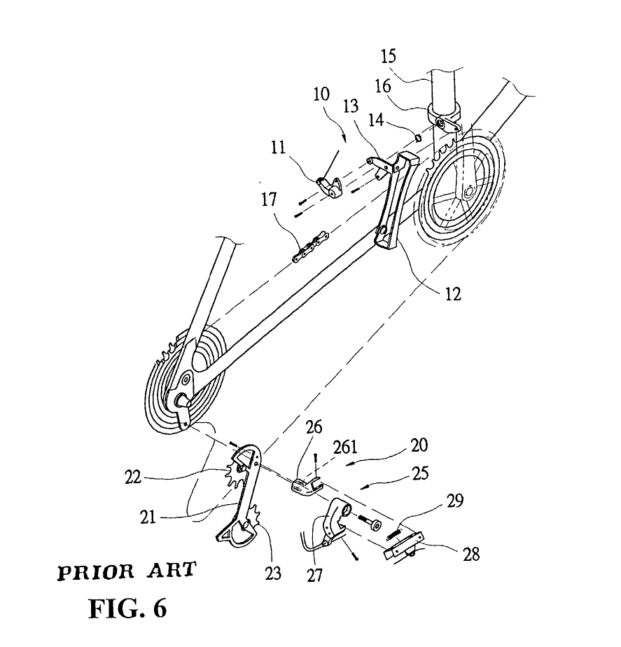

FIGS. 7A and 7B are a side and a front plan views of the conventional front gearshift module when the gearshift triggering is in action.

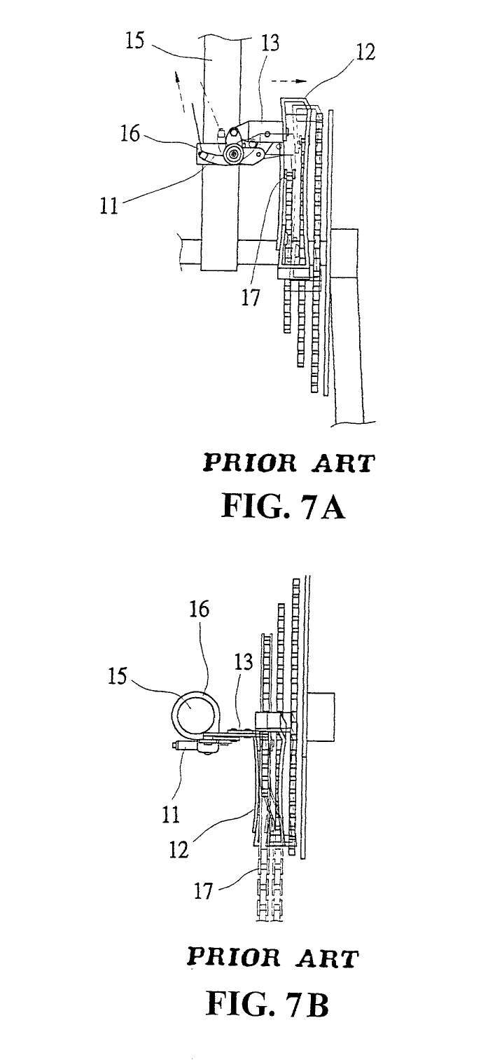

FIGS. 8A and 8B are a side and a front plane views of the conventional rear gearshift module when the gearshift triggering is in action.

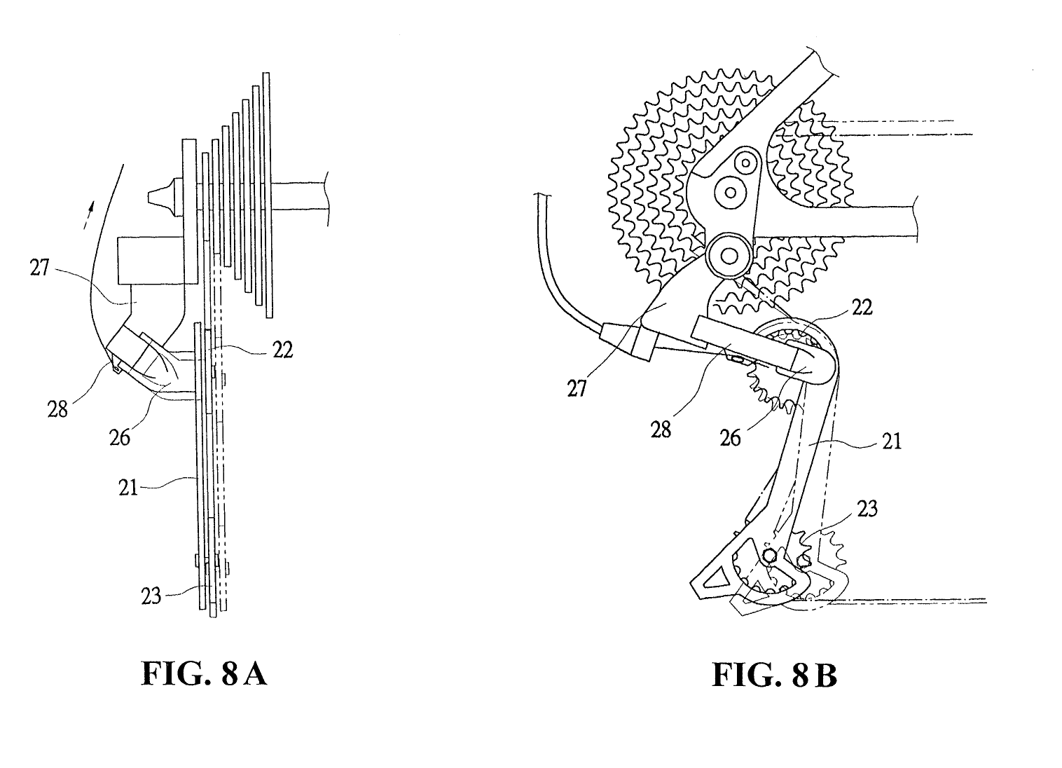

### DETAILED DESCRIPTION OF THE PRESENT INVENTION

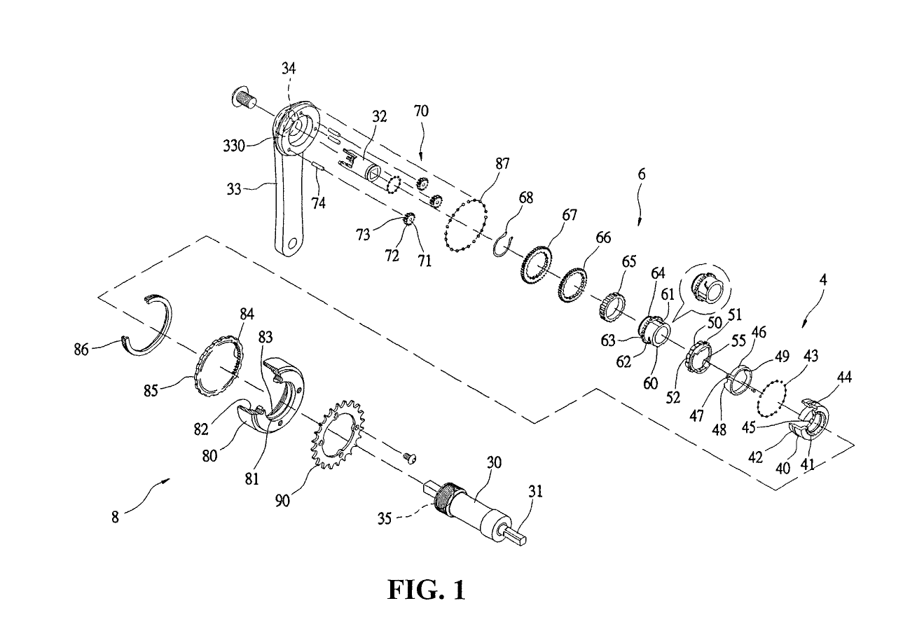

The present invention relates to an improvement of front gearshift structure, which can rapidly change the gearshift, and also in motionless condition, as shown in FIG. 1. The front gearshift module has a crank pedestal 30 mounted with a triggering module 4. The triggering module 4 is in conjunction with an external gear module 6. The crank is mounted with a planetary gear module 70 corresponding to the external gear module 6. The external side of the planetary gear module 70 is mounted with an internal gear module 8. These combinations can achieve the gearshift objective of the front gearshift module.

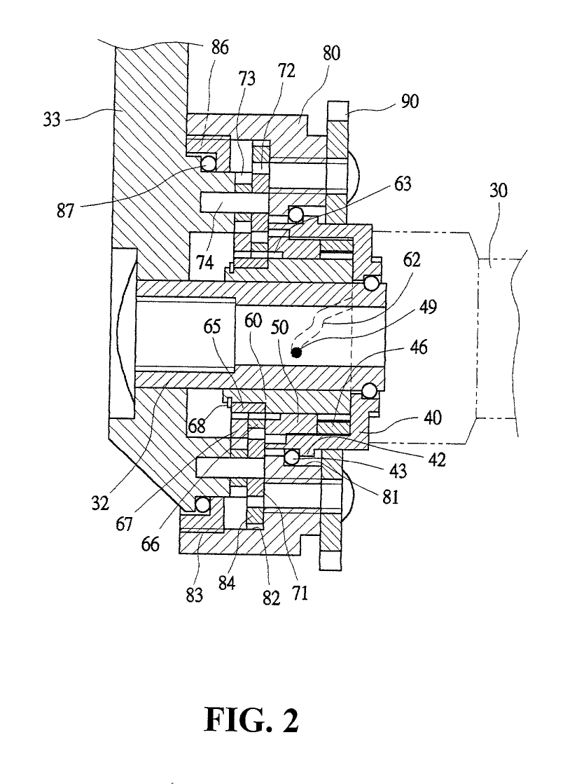

The detailed structure of the present invention is shown in FIGS. 1 and 2. The crank pedestal 30 is secured within the five through-tube and has both ends used a pivot crank axle 31 to mount with a clutch axle sleeve 32. The clutch axle sleeve 32 is mounted with a clutch recess hole 34 of the crank 33, for user can drive the bicycle through pedaling of crank 33.

The above triggering module 4 relates to one end of the crank pedestal 30 is provided with a set of teeth edge 35. The teeth edge 35 can relatively provide the engagement with the teeth 41 with the position collar 40. The external side of the position collar 40 is also secured with a set of ball bowl module 43 with a support of a protrusion edge 42. The circumference of position collar 40 is provided with a sectional recess 44; a position collar 40 different from one internal edge of the crank pedestal 30 with teeth 45. The internal edge of the position collar 40 is also mounted with a triggering ring 46; the external edge of the triggering ring 46 also is also provided with a securing thread plate 47 such that it can pass through the sectional recess 47. The triggering ring 46 is different from the edge of the crank pedestal 30 and is provided with two outward extending protrusion edge plates 48. The two protrusion edge plates 48 are relatively provided with a protrusion point 49. The inside of the position collar 40 is mounted with a press sleeve 50; the press sleeve 50 edge is formed with a triggering sleeve 46 which can press down the wing plate 51, and the internal edge of the two wing plates 51 is formed into a dovetail seat 55. Again, the press sleeve 50 different from the triggering ring 46 edge is formed with teeth 52, and can provide the position of teeth 45 over the internal edge of the position collar 40.

The external gear module 6 can pass through the press sleeve 50 of the triggering module and the gear axle sleeve 60 of the triggering ring 46. The external edge of the gear axle sleeve 60 is formed into a press sleeve 50 and a dovetail 55 of dove recess 61, so that the gear axle sleeve 60 will be restricted as not to rotate. The external edge of the gear axle sleeve 60 in relation to the triggering ring 46 of the protrusion point 49 is separately formed with a gearshift propel bending recess 62, which can control the forward and backward movement of the gear axle sleeve 60. The external edge of the gear axle sleeve 60 is formed into a set of teeth 63 and it also forms a C-shaped clip 68, which is coupled with a ring clip recess 64. The teeth 63 and the C-shape clip 68 of the gear axle sleeve 60 are mounted with a wheel seat sleeve 65. The wheel seat sleeve 65 is coupled with a primary and secondary of external gear sleeve 66, 67 of different diameters, which can relatively provide the engagement of the planetary gear module 70.

The planetary gear module 70 using the axle lever 74 is mounted at the side face of the crank 33; and on the axle lever 74, a gear 71 having a big and small wheel 72, 73 is pivotally mounted. The wheel 72 and 73 for gear 71 can separately engage with the primary and secondary of external gear sleeve 66, 67. The external edge of the planetary gear module is mounted with an internal gear module of a gear disc 90.

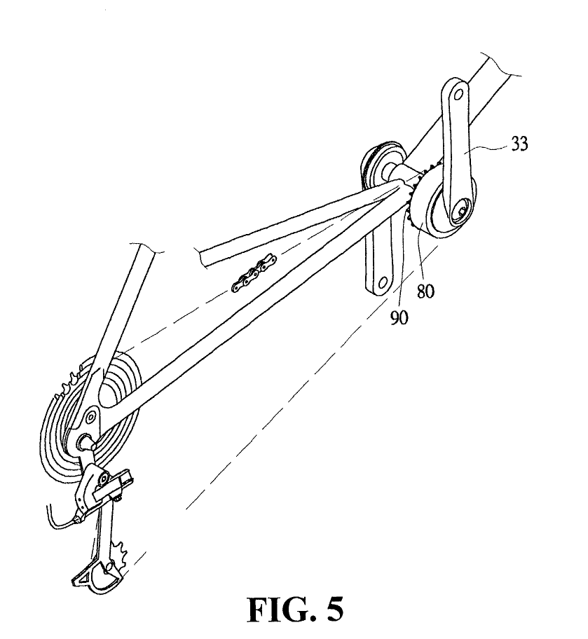

The internal gear sleeve module 8 is provided with a housing 80, and the housing 80 relative to the internal edge of the crank pedestal 30 is provided with a ball bowl module 43. Besides, the crank pedestal 30 can relatively rotate with each other, and also has a function to position. The inside of the housing 80 is provided with a set of teeth 82, and the teeth 82 can couple with the external edge relative to the internal gear sleeve 84 of the gear 85. The internal gear sleeve 84 is engaged with the planetary gear module 70 at the big wheel 72 of the gear 71. Again, the inside of the housing 80 is also provided with inner screw thread 83 for relatively fastening with an external screw thread of axle sleeve 86. The axle sleeve 86 and the ball bowl seat 330 of the crank 33 are relatively engaged with the ball bowl module 87 so that the crank 33 can relatively rotate with the housing 80. With this combination, it can rapidly change gearshift velocity and also in a motionless condition for the improved structure of the front gearshift module. FIG. 5 shows the application of the present invention on the bicycle.

The application of the present of invention is shown in FIG. 1 and 2. When the user does not pull the gearshift thread, the triggering ring 46 of the triggering module 4 will not rotate. Thus, the protrusion point 49 of triggering ring 46 will stop at the starting point of the gearshift propel bending recess 62 of the gear axle sleeve 60. Therefore, the gear axle sleeve 60 remains at its place. The primary and the secondary external gear sleeve 66 and 67 are also corresponding to the wheel sleeve seat 65. The wheel sleeve seat 65 and the gear sleeve seat 60 can rotate with each other, and, the crank 33 connected to the gear 71 of planetary gear module 70 can directly drive the internal gear sleeve 84 of the housing 80. It further drives the gear disc 90, which is fastened to the housing 80, and forms the first stage of velocity output.

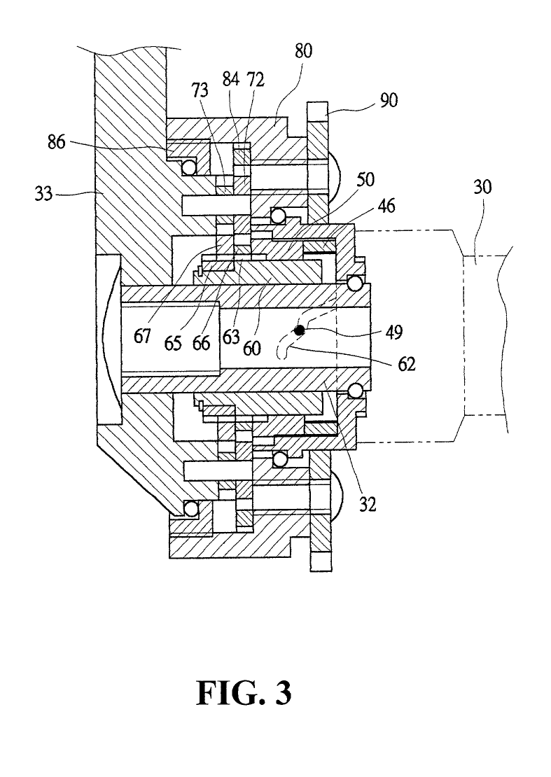

When the user controls the gearshift thread by pulling the triggering ring 46 of triggering module 4, as shown in FIG. 3. The triggering ring 46 will start to rotate. The dovetail recess 61 and the dovetail seat 55 restrict the gear axle sleeve 60, and it does not rotate. Under the combination of the functions of the protrusion point 49 of triggering ring 46 and the gearshift propel bending recess 62, the gear axle seat 60 will move in a parallel direction towards the crank 33 side. Further, the protrusion point 49 will set the position at the middle of the gearshift propel bending recess 62. At this instance, once the gear axle sleeve 60 has been pulled out, the wheel sleeve seat 65 will also move at the same time and the primary external gear sleeve 66 leaps over the teeth 63 of the gear axle sleeve 60. Thus, the gear 71 rotation of the planetary gear module 70 will be affected with the function of the primary external gear sleeve 66 and a second stage gearshift is formed subsequently.

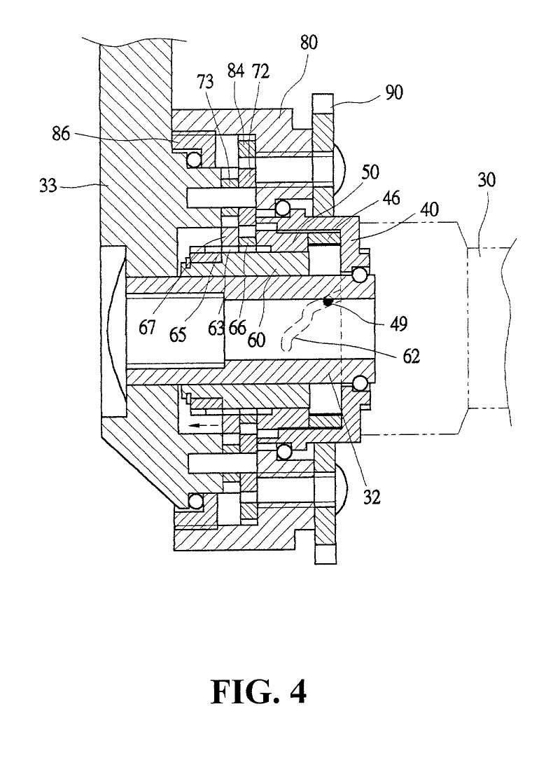

Moreover, when the user further drives the gearshift thread, as shown in FIG. 4, the triggering ring 46 will rotate again. The gear axle sleeve 60 under the function of protrusion point 49 of triggering ring 46, the gearshift propel bending recess 62 will move in a parallel direction toward the crank 33 side again and the protrusion point 49 sets the position at the bottom edge of the gearshift propel bending recess 62. Once the gear axle sleeve 60 has been pulled out further and the wheel sleeve seat 65 will move at the same time, the secondary external gear sleeve 76 will leap over the teeth 63 of the gear axle sleeve 60. Thus, the gear 71 rotation of the planetary gear module 70 will be affected with the function of the secondary external gear sleeve 67. The external diameter of the secondary external gear sleeve 67 is bigger than the primary external gear sleeve 66, so the rotation of the gear 71 will be slower. Further the housing 80 and the gear disc 90 velocity will be slower and a third stage gearshift is formed subsequently.

Through the above structure design, the present of invention can achieve at least the following functions and efficiencies:

(1). Designing Flexibility

The present of invention relates to a direct securing of crank pedestal 30 and the initial gear position of crank 33. The volume is smaller than the conventional one. It does not need a triggering thread module to triggering the chain and also structure for securing the housing and the triggering module are not needed in order to achieve the purpose of simplify the structure. Thus, it not only avoids the disturbances of the user to step onto the crank 33, but also increases the frame designing flexibility.

(2). Gearshift Being Rapid

The present of invention relates to gearshift, by employing the rotation of the triggering ring 46 to directly drive the gear axle sleeve 60 to a parallel direction as to achieve the purpose of gearshift. It only requires the gear axle sleeve 60 to move parallel to its securing point to accomplish gear shifting at the same time. The conventional method requires a waiting of the chain to run over half of the gear disc first before it can change gearshift. The present invention can assure the increase of the efficiency of the gearshift.

(3) Gearshift in Motionless Condition

As mentioned earlier, the present invention uses the parallel movement of the gear axle sleeve 60 to accomplish gear shifting. It only requires the driven of the triggering ring then it moves in parallel at the same time. Thus, the present invention provides the bicycle with gearshift in a motionless condition. If compare to the conventional method, the bicycle has to be in the process of rotation before it can change gearshift as mentioned; the present of invention ensure to provide more application of flexibility.

(4) Easy Adjustment of Gearshift

Due to the fact that the gearshift propel bending recess 62 on the gear axle sleeve 60 is provided with a multistage winding so that the protrusion point 49 can stop at specific position so that the action of the gearshift is rapid and assurance.

While the invention has been described with respect to preferred embodiment, it will be clear to those skilled in the art that modifications and improvements may be made to the invention without departing from the spirit and scope of the invention. Therefore, the invention is not to be limited by the specific illustrative embodiment, but only by the scope of the append claims.

I claim:

1. An improved structure of bicycle front gearshift module having being mounted with a crank pedestal of crank axle and a crank, the crank pedestal being mounted with a triggering module connected to an external gear module, over the crank, a corresponding planetary gear module of external gear module being provided, and the external edge of the planetary gear module being mounted with an internal gear module of gear disc, wherein
(a) the triggering module: the triggering module has one edge of the crank pedestal engaged with a position collar, and the position collar circumference forms a sectional recess, inside the position collar, a securing thread plate of the triggering ring is provided, and the securing thread plate can pass through the sectional recess of the position collar, a triggering ring is different from the edge of the crank pedestal has two outward extending protrusion edge plates, inside the protrusion edge plate, a corresponding protrusion point is formed, and the position collar is also engaged with a press sleeve that can press down the triggering ring;
(b) the external gear module: the external gear module is provided with a gear axle sleeve that can pass through the press sleeve and the triggering ring, and a triggering axle sleeve is engaged with the press sleeve, and can only move in a horizontal movement without rotation, the external edge of the gear axle sleeve relative to the triggering ring of protrusion point is separately formed of a multistage of gearshift propel bending recess, and the external edge of the gear axle sleeve forms a set of teeth, one side of the gear axle sleeve pivotally mounted with a wheel seat having the same diameter with the teeth, and the wheel seat is engaged with a difference diameter of primary and secondary external gear sleeves, and these gear sleeves can couple with the teeth;
(c) the planetary gear module: the planetary gear module has the crank side face which is fastened with a number of axle levers, over the axle lever pivot is a big and small wheel of gears are mounted and these gears can engage with the primary and the secondary gear sleeves;
(d) the internal gear module: the internal gear module has a housing and the housing is coupled with an internal gear sleeve engaged with the gear big wheel of the planetary gear module, the external side of the housing is fastened with a gear disc.

2. The improved structure of bicycle front gearshift module of claim 1; wherein the position collar relative to one edge of crank pedestal is provided with a set of teeth, and the crank pedestal also relatively forms a teeth edge so that the position collar can couple with the crank pedestal.

3. The improved structure of bicycle front gearshift module of claim 1; wherein the external edge of the position collar is provided with a set of protrusion edge, and the housing relative to the internal edge of the crank pedestal is provided with a ball bowl module, and the ball bowl seat, and the protrusion edge is fastened with the ball bowl module, and both the bowl module and the bowl seat relatively rotate with each other and also provide a position function to the housing.

4. The improved structure of bicycle front gearshift module of claim 1, wherein the position collar which is different from one edge of the crank pedestal forms into teeth, and the press sleeve relative to its edge also forms into teeth so that the press sleeve can couple with the position collar inside.

5. The improved structure of bicycle front gearshift module of claim 1, wherein the edge of the press sleeve is formed with a triggering ring and can press down the wing plate, and the internal edge of the wing plate forms a dovetail seat, and the external edge of the gear axle sleeve also is formed into two relatively dovetail recess for the dovetail seat so that the gear axle sleeve is restricted to rotate.

6. The improved structure of bicycle front gearshift module of claim 1, wherein the external edge of the gear axle sleeve forms into a C-shape clip and is secured with a ring clip recess so as to restrict the wheel sleeve seat.

7. The improved structure of bicycle front gearshift module of claim 1, wherein the internal edge of the housing is formed into a set of teeth, and the external edge of the internal gear also relatively forms into teeth so that the internal gear can couple with the inside of the housing.

8. The improved structure of bicycle front gearshift module of claim 7, wherein the internal housing is formed into an inner screw thread for fastening with a axle sleeve, the axle sleeve and the crank of ball bowl module are relatively fastened with the ball bowl module so that the crank can rotate relatively to the housing.
